(19) United States
(12) Patent Application Publication
(10) Pub. No.: US 2003/0052427 A1
(43) Pub. Date: Mar. 20, 2003

(54) Retaining device for an extrusion die

(76) Inventor: Reinhold Kossl, Wartberg/Krems (AT)

Correspondence Address: COLLARD & ROE, P.C., 1077 Northern Boulevard, Roslyn, NY, 11576-1696, US

(21) Appl. No.: 10/218,026

(22) Filed: Aug. 13, 2002

(30) Foreign Application Priority Data
Aug. 14, 2001 (AT) A 1272/2001

(51) Int. Cl. B29C 47/12

(52) U.S. Cl. 264/39; 425/183; 425/192 R

(57) ABSTRACT

The invention relates to a retaining device (26), in particular on an extruder (2), for several die plates (27) which can be arranged immediately one after the other in the extrusion direction (6) to form an extrusion die (28) with an inlet region (29) and an outlet region (30). At least two tension elements (37) are provided spaced at a distance apart from one another perpendicular to the extrusion direction (6), which can co-operate with the die plates (27) respectively in the region of opposing first side ends (34) which they span. At least one holding element (40) projects, in an end region (39) of the tension element (37) which may be directed towards the outlet region (30), into the cross-sectional surface bounded by the side ends (34) of the die plates (27) disposed one after the other and engages round these side ends (34). A clamping mechanism (44) is provided between the two spaced apart end regions (39, 42) of the tension elements (37) and/or between the tension elements (37) and the die plates (27) of the extrusion die (28) co-operating therewith. The invention further relates to a shaping system (3) with a retaining device (26) and a method of retaining an extrusion die (28).

### BACKGROUND OF THE INVENTION

1. Field of the Invention

The invention relates to a retaining device, particularly on an extruder, for several die plates which can be arranged immediately one after the other in the extrusion direction to form an extrusion die, with an inlet region and an outlet region, a shaping system with at least one extrusion die made up of individual die plates arranged one after the other with at least one flow passage arranged therein, and a retaining device for holding the die plates together in the extrusion direction, as well as a method of holding at least one extrusion die comprising several die plates immediately one after the other on an extruder.

2. The Prior Art

Shaping tools, in particular for making hollow sections, are known from pages 200 to 202 of the text book “Kunststoff-Maschinen-Führer” published in 1984 by Carl Hanser Verlag Munich Vienna, which consist of a plurality of die plates arranged immediately one after the other in the extrusion direction and are held together in a plate stack by means of a plurality of screw connections. Accordingly, individual plates are grouped together to form a respective group of plates, which are held together by means of connecting screws at the outlet of the extruder and together form the extrusion die. Operating under defined conditions, it is not always possible to guarantee that mutually facing end faces will always abut in a sealing arrangement with one another in the region of the flow passage in all applications.

Other clamping mechanisms for the cassette used for shaping plate-type components of plastics are known from EP 0 270 816 B1 and EP 0 936 050 A2, in which the shaped strip to be clamped for shaping purposes is retained by displaceable head parts arranged transversely to the extrusion direction co-operating with clamping cylinders on the extrusion head. In order to produce a wall of uniform thickness in the component to be produced, separate clamping cylinders are also provided along the length of the shaped strip transversely to the extrusion direction, by means of which the gap width can be set during operation.

### SUMMARY OF THE INVENTION

The underlying objective of the present invention is to propose a retaining device for an extrusion die, a shaping system with a retaining device of this type and a method of holding an extrusion die with this retaining device, by means of which a sealing abutment can be obtained between facing end faces of the die plates around the periphery of the flow passage of the extrusion die. This retaining device is also intended to enable dies on the extruder to be replaced rapidly in a short time so that the extruder has to be shut down for as short a time as possible.

This objective is achieved by the invention due to the fact that at least two tension elements are provided at a distance apart from one another perpendicular to the extrusion direction, which can be assigned to the die plates respectively in the region of oppositely lying first end faces so as to span the latter, and the tension elements extend at least between the inlet region and the outlet region, and in an end region of the tension element which can be turned towards the outlet region at least one holding element projects into the cross-sectional surface bounded by the side ends of the co-operating die plates and engages behind this side end, and a clamping mechanism for the die plates of the extrusion die acting in the extrusion direction is arranged between the two spaced apart end regions of the tension elements and/or between the tension elements and the die plates of the extrusion die co-operable therewith. The surprising advantage achieved as a result is that the tension elements assigned to the end faces of the die plates are able to apply a high pressure force to the reciprocally facing end faces of the die plates, starting from the two end faces directed towards the inlet and outlet region, in particular in the inlet region, immediately adjacent to the flow passage, because the highest mass pressure builds up inside the flow passage in the region immediately adjoining the extruder. Moreover, because the extrusion die is supported at the outlet of the extruder almost continuously all round, the force can be transmitted uniformly. Dispensing with the connecting screws that have been used as standard until now, the die plates can be made to smaller external dimensions—in other words in terms of their end faces aligned perpendicular with the extrusion direction—as a result of which the force can be introduced close to the flow passage. This makes for a simple retaining device and one which is above all simple in terms of assembly requirements, by means of which the individual die plates arranged one after the other can be retained in a sealing abutment with one another in the region of the longitudinal extension of the flow passage, in particular in the first portion of the flow passage, including when the extruder is operating.

Also of advantage is another embodiment in which the tension element at the two end regions spaced apart from one another in the extrusion direction respectively has a holding element projecting above a flat face of the tension element towards the other tension element lying opposite, which enables force to be transmitted even more efficiently into the two end faces of the die plates and, as a result, obtains an even more secure abutment of the mutually facing end faces of the die plates.

In another advantageous embodiment, the tension element has another respective supporting element on at least one of the end regions spaced apart from one another in the extrusion direction or on both the end regions spaced apart from one another in the extrusion direction, projecting above the other flat face of the tension element on the faces remote from one another, which enables the force at one but preferably at both end regions of the tension elements to be transmitted uniformly on the side remote from the extrusion die.

As a result of the design of the retaining device in which the holding element or the supporting element has a hook-shaped cross section in a plane aligned with the direction of longitudinal extension and perpendicular to the flat faces of the tension element, or the two holding elements or supporting elements on at least one end region of the tension element is hammer-shaped in a plane aligned with the direction of longitudinal extension and perpendicular to the flat faces of the tension element and respectively have the cross section projecting above the flat faces, a force can be positively transmitted to the tension elements and a certain clamping effect is simultaneously also produced, ensuring that the two components engaging with one another are reliably placed in abutment.

Another embodiment, in which a transition region with a rounded piece is provided between the tension element and the holding element or supporting element, prevents impacts and thus assures reliable, fault-free operation over a long period.

It is also of advantage if the tension element is provided in the form of a plate or bar-shaped component, which allows higher forces to be transmitted and simultaneously ensures full surface coverage of the individual die plates, as a result of which heat can be applied uniformly when connected to tempering elements and a certain amount of heat stored.

In another embodiment of the retaining device, the tension element extends longitudinally in the extrusion direction and is longer than a length of the extrusion die co-operating with it, the advantage of which is that the clamping device can be arranged almost centrally relative to the flow passage between the end region of the tension element and the inlet and/or outlet region of the extrusion die.

In another embodiment, the width of the tension element and the holding element, and optionally the supporting element transversely to the longitudinal extension of the tension element, more or less corresponds to a length of an end face of the die plate co-operating with the tension element in the same direction, so that force can be introduced across virtually the full width of the die plates via the tension element into the latter, which makes for an even better pressure distribution of the abutment pressure between the individual die plates in the region of the flow passage.

In another embodiment, the tension elements are disposed parallel with one another and parallel with the extrusion direction when in the operating position, which means that force can be transmitted to the individual die plates and hence on to the extruder in an exact perpendicular alignment, ensuring that transverse forces and any resultant transverse stress is reliably avoided. Similarly, it is also possible to avoid virtually any bending stress on the tension elements, enabling a planar abutment of the tension elements in the region of the end faces of the die plates.

It is also of advantage if the clamping mechanism device is provided in the form of a cylinder-piston arrangement, since this will require the smallest amount of space but enable a high degree of force to be applied to the stack of individual plates to be clamped.

In one embodiment, the piston of the clamping mechanism can be supported against the end face of the first die plate directed towards the inlet region and the clamping force can be transmitted across virtually the entire cross section of the piston to the individual die plates, thereby obtaining a secure and sealing abutment of the mutually facing end faces in the region of the flow passage immediately adjoining the extruder because the highest pressure forces inside the flow passage occur immediately after the extruder.

This being the case, it is of advantage to use an embodiment of the retaining device in which a connecting mechanism is provided on the piston as a means of providing a retention on the extruder because this allows a transition from the outlet of the extruder via the piston through to the extrusion die to be provided over the shortest possible path and simultaneously affords a simple means of fixing the retaining device on the extruder.

In one advantageous embodiment, the cylinder of the tensioning device is actively connected to, in particular supported by, the two holding elements of the tension elements that are co-operable with the inlet region, so that the clamping forces are transmitted directly from the cylinder of the clamping mechanism to the tension elements.

It is also of advantage if the cylinder has a respective radius complementing the rounded piece on the portions assigned to the holding elements and co-operating therewith because a pivoting motion of the tension element, needed in order to place the extrusion die in the released position, can be obtained due to the co-operation of the rounded holding elements with the portions on the cylinder, which simultaneously produces an abutment between the two co-operating parts over a large surface area.

In other embodiments of the retaining device, a pressing force is respectively applied to the faces of the tension element remote from the extrusion die between opposing end regions and with it a clamping force is transmitted to the tension elements, resulting in a counter-force, in conjunction with the clamping mechanism and the holding elements projecting into the cross-sectional surface of the extrusion die, thereby preventing any deformation of the tension elements whilst pressure is being applied. The pressing force also prevents any deformation of the extrusion die due to the high pressing forces transmitted from the clamping mechanism to the side of the die plates remote from the flow passage. If the pressure forces applied by the pressure system are selected so as to be higher than the forces applied by the clamping mechanism, the end regions of the tension elements are pushed in the direction of the extrusion die, which ensures that any undesirable deformation of the flow passage inside the extrusion die and hence any change in the section geometry is prevented.

In another embodiment, the sum of the active piston surfaces of the rams assigned to the pressure system are the same as or greater than an active cylindrical surface of the clamping mechanism or a cylinder chamber or tensioning device is connected by a line to the cylinder chambers of the individual pressure generators, which means that the same pressure is always built up inside the pressure system of the individual cylinder chambers and, because the active piston surfaces are specifically selected relative to one another, a directed force is always applied to the tension elements and hence to the extrusion die.

In another option, the cylindrical housing may have a respective radius complementing the rounded piece on the portions assigned to the supporting elements and co-operating therewith, since this will permit a certain pivoting motion of the tension element relative to the cylindrical housing and certain manufacturing tolerances can additionally be compensated, in particular due to the fact that the pressure elements are disposed at an angle to the tension elements.

In one embodiment of the retaining device, the two cylindrical housings are permanently joined to one another in the region of the side remote from the clamping mechanism by means of a respective retaining element specifically of a bar-shaped design, in order to prevent any reciprocal shifting, in particular tilting, of the two cylindrical housings relative to one another, which means that when force is being applied via the pressure systems to the tension elements on the two opposing sides of the extrusion die, the transmitted force is guaranteed to be uniform.

It is also of advantage if the cylinder of the clamping mechanism has side faces directed towards the two holding elements and abutting with them because the cylinder of the clamping mechanism is always guided when pressure is being applied, thereby ensuring that it remains in a fixed position relative to the extruder and the extrusion die is maintained in an exact hold.

An advantage is also to be had if a tempering element is provided on at least one, preferably both of the flat faces of the tensions elements directed towards one another, at least in certain regions, or if the tempering element is provided on the tension element in a fixed mounting because this enables the temperature to be influenced, including during operation, making it possible to cool and/or heat the extrusion die, for example, as a result of which the temperature of the extrusion die close to the flow passage can be reliably and above all accurately controlled as a result of the mounting on the extrusion die, whilst occupying the least possible space.

Irrespective of the above, however, the objective of the invention is also achieved by means of a shaping system with a retaining device as proposed by the invention and an extrusion die, in which the individual die plates are placed in abutment one against the other by the retaining device, when in the operating position and whilst the mass flow placed under pressure passes through the flow passage, by the mutually facing end faces in the region of the flow passage, in particular in the first section directed towards the inlet region, at a predeterminable minimum pressure which is approximately 20% higher than the mass pressure of the mass flow in this section. The advantage of this is that, firstly, a force is directed by the retaining device onto the individual die plates disposed one after the other and, secondly, the time needed to replace one die with another die can be effected in a very short period of 5 to 20 seconds, for example. As a result of this short replacement time, the amount of time during which the extruder has to be shut down is also kept very short, and the time needed to prepare the plastics material and the run-up of the extruder to the point at which a correctly prepared and softened plastics is available for manufacturing an object with a different cross section can also be significantly reduced.

In another embodiment of the shaping system, the predeterminable minimum pressure between the abutting end faces is applied continuously around the entire circumference of the flow passage, the advantage of which is that a secure abutment between the reciprocally facing end faces is guaranteed around the entire circumference of the flow passage, thereby preventing any of the mass of softened plastics from undesirably getting between the reciprocally facing die plates.

It is also of advantage if a centring arrangement is provided between the piston of the clamping mechanism and the end face of the die plate directed towards the inlet region, which will enable the already pre-heated extrusion die to be simply and rapidly centred relative to the extruder when making a changeover and obviates the need for complex assembly.

In one embodiment, the piston of the clamping mechanism has an orifice in flow communication with the flow passage through the die plates, which allows force to be transmitted via the tension elements to the extrusion dies whilst simultaneously requiring a minimum of space, and the plastics mass is able to pass inside this clamping mechanism.

In another embodiment, in which the die plates assigned to the outlet region and co-operating with the tension elements and the holding elements are designed with a respective radius complementing the rounded piece of the portions co-operating with them, force can be reliably transmitted in the contact region between the tension elements and the die plates and the design of rounded piece co-operating with the radius prevents any transverse displacement of the extrusion die.

It is also of advantage if the individual die plates forming the extrusion dies are provided with a clamping mechanism holding the die plates together in the preparation and removal position or if the clamping mechanism co-operates respectively with the two other end faces, because the individual die plates arranged one after the other can be retained in abutment with one another in their aligned position with a minimum force to enable the entire stack of the die plates to be prepared and the die changed in this state in the shortest of times.

In another embodiment in which a tempering element is provided for the clamping mechanism or mechanisms, preferably abutting with the end faces, the prepared die plates can be pre-heated to a certain temperature so that the die can be changed subsequently, immediately after the extrusion process, without any further loss of time.

Other embodiments of the shaping system enable an extrusion die in operation to be rapidly changed for a prepared die due to the die-changing mechanism and the dies are pre-positioned exactly to match the extruder, which also reduces the effort involved in the positioning process.

In another option, the individual die plates may be of almost the same external dimension in a plane perpendicular to the extrusion direction or centring elements are provided between the die plates arranged immediately one after the other, and using a large number of identical components makes it possible to position the individual die plates relative to one another without the need for additional elements.

The objective of the invention is also achieved by a method of holding at least one extrusion die made up of several die plates arranged one after the other, due to the fact that when the tension forces to be applied in the operating position and during the extrusion process are transmitted to the individual die plates by at least two oppositely lying tension elements spanning the extrusion die externally at its side ends and the extrusion die, holding elements projecting respectively in its inlet region and outlet region into the cross section of the die plates delimited by the side ends and engaging round these side ends, the die plates are brought into abutment with one another by reciprocally facing end faces without any clearance in a region enclosing a flow passage. The resulting advantages are that, because the force needed to produce the clamping force in the region around the flow passage is transmitted in the inlet region immediately adjacent to the flow passage, a minimum abutment pressure can also be produced between the two abutting die plates in the region immediately adjoining the extruder in the transition region thereof. Consequently, the softened plastics material is also prevented from getting between the mutually facing end faces during operation of the extruder and as the mass flow of plastics passes through the flow passage. This is possible primarily because of the almost continuous all-round support of the extrusion die at the outlet of the extruder and the uniform transmission of force to the holding elements engaging round the end faces, which are preferably arranged extending around the entire width of the die plates.

In one procedure, heat is applied to another extrusion die made up of several die plates arranged one after the other in its preparation position, whereupon the extruder is stopped and the first extrusion die released from the retaining device, the first released extrusion die together with the mass flow of softened plastics disposed therein being lifted more or less in the extrusion direction away from the outlet of the extruder, so that the mass flow between the outlet from the extruder and the inlet region to the extrusion die is stretched or expanded and, simultaneously with this adjustment process, the expanded mass flow is separated and the displacement towards the removal position is continued, and the other extrusion die is then moved from its preparation position into the released position inside the retaining device, after which the other extrusion die is held stationary on the extruder by the retaining device, the advantage of this being that the down time of the extruder can be kept very short compared with conventional fixing methods and a very short time of only 5 to 20 seconds, for example, is needed in order to change from one die to the next die. As a result of this short replacement time, the down-time of the extruder is also kept very short and the requisite time needed from the time of preparing the plastics material and passing it through the extruder, until a correctly prepared and softened plastics is obtained for producing an object with a different cross section, is also very significantly reduced.

Another advantageous system is obtained if the mass flow still leaving the extruder is separated immediately prior to positioning the other extrusion die on the extruder because this will allow the process of docking the prepared extrusion die on the extruder to proceed unhindered by plastics material getting in the way in the region of the centring arrangement between the components to be positioned relative to one another.

Finally, in another variant of the method, the two extrusion dies are coupled with one another before making an adjusting movement and the two extrusion dies are moved simultaneously, the advantage of this being that the die which is in operation is uncoupled and removed and the prepared die simultaneously applied to the outlet of the extruder in a single, simultaneous process, which again shortens the time needed to change dies and results in a shorter down-time of the extruder.

### BRIEF DESCRIPTION OF THE DRAWINGS

The invention will be described in more detail with reference to examples of embodiments illustrated in the drawings, wherein

FIG. 1 is a simplified schematic diagram showing a side view of an extrusion plant with a retaining device as proposed by the invention;

FIG. 2 is a simplified schematic diagram, seen in side section and on an enlarged scale, of the retaining device with an extrusion die retained therein;

FIG. 3 is a plan view of the retaining device illustrated in FIG. 2;

FIG. 4 is a view of the retaining device illustrated in FIGS. 2 and 3, seen from the right-hand side;

FIG. 5 is a view of a die plate from a conventional extrusion die, indicating the pattern of the pressure zones;

FIG. 6 shows the pressure zones on a die plate, which is held together to form an extrusion die by the retaining device proposed by the invention;

FIG. 7 is a simplified schematic diagram showing a side view in section of the retaining device illustrated in FIGS. 2 to 4 but with the extrusion die in the released position;

FIG. 8 is a simplified schematic diagram showing a front view of two extrusion dies arranged adjacent to one another, one of which is held by the retaining device, and a die-changing mechanism;

FIG. 9 is a plan view of the two extrusion dies illustrated in FIG. 8;

FIG. 10 is a plan view of the die-changing mechanism on an enlarged scale, with the extrusion dies in the position illustrated in FIG. 8;

FIG. 11 shows the die-changing mechanism illustrated in FIG. 10, but in an intermediate position whilst changing the die;

FIG. 12 shows the die-changing mechanism illustrated in FIGS. 10 and 11 in the other end position, in which the first extrusion die has been moved away from the extruder;

FIG. 13 shows a front view of the die-changing mechanism illustrated in FIG. 10;

FIG. 14 is a simplified schematic diagram, showing a side view in section and on an enlarged scale, of another embodiment of the retaining device with an extrusion die held therein;

FIG. 15 is a simplified schematic diagram, in a side view in section and on an enlarged scale, of another embodiment of the retaining device with an extrusion die held therein.

### DETAILED DESCRIPTION OF PREFERRED EMBODIMENTS

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc,. relate to the drawing specifically being described and can be transposed in terms of meaning to a new position when another position is being described. Individual features or combinations of features from the different embodiments illustrated and described may be construed as independent inventive solutions or solutions proposed by the invention in their own right.

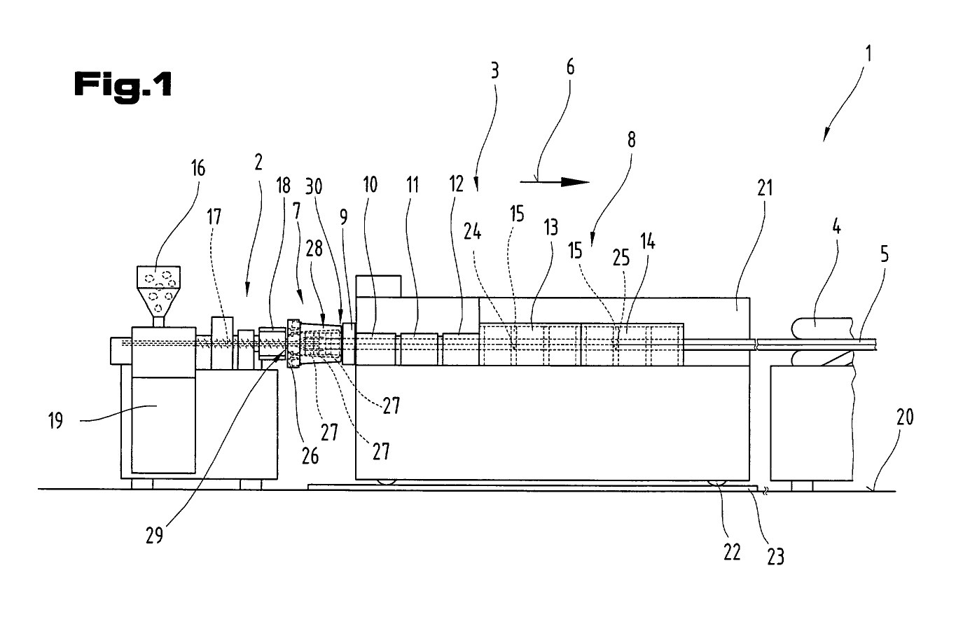

FIG. 1 illustrates an extrusion plant 1, consisting of an extruder 2, a shaping system 3 arranged downstream thereof and a crawler track 4 for an extruded article 5 disposed downstream of it. The purpose of the crawler track 4 is to draw the article 5, for example a section, in particular a hollow section of plastics such as used for building windows and/or doors, in the extrusion direction 6 from the extruder 2 through the entire shaping system 3. In this embodiment, the shaping system 3 consists of at least one extrusion tool 7 assigned to the extruder 2 and retained thereon, e.g. an extrusion die, a calibrating system 8 with at least one but preferably several calibrating tools 9 to 12 and at least one but preferably several vacuum pressure tanks 13 and 14, in which several calibration plates 15 are disposed. Some of the individual calibration plates 15 may also serve only a supporting function as supporting apertures for the article 5.

Disposed in the region of the extruder 2 is a container 16, from which a material is supplied, for example a mixture or a granulate for forming a plastics material, prepared in the extruder 2 by means of at least one screw conveyor 17, for example kneaded and blended before being delivered to the extrusion tool 7. The extruder 2 also has a plasticizing unit, by means of which the material is heated, plasticized and conveyed in the direction of the extrusion tool 7, and, as it is carried therethrough by the screw conveyor 17, being subjected to pressure and heated or cooled by additional tempering systems 18 if necessary, depending on its intrinsic properties. Before the inlet to the extrusion tool 7, the mass flow of plasticized material is formed to the desired cross-sectional shape as it is fed into transition zones.

The extrusion tool 7, the plasticizing unit and the container 16 are supported and retained on a machine bed 19, the machine bed 19 being placed on a level standing surface 20, for example a flat hangar floor.

In the embodiment described as an example here, the entire calibration system 8 is arranged and retained on a calibrating table 21, the calibrating table 21 being supported by means of rollers 22 on tracks 23 secured to the standing surface 20. The purpose of mounting the calibrating table 21 in this way is to enable the entire calibrating table 21 with the devices and apparatus mounted thereon to be moved backwards and forwards from the extrusion tool 7 in the extrusion direction 6—indicated by the arrow. To make such displacement easier and more accurate, the calibrating table 21 is provided with a drive system, not illustrated in detail, permitting a selective and controlled longitudinal movement of the calibrating table 21 to the extruder 2 and the extrusion tool 7 or away from the extruder 2. Any solutions and units known from the prior art may be used for driving and controlling this driving gear.

The calibration tools 9 to 12 of the calibration system 8 are supported on a mounting plate and designed to operate in a vacuum calibration system, whereby the extruded article 5 is calibrated within the individual shaping and calibration tools 9 to 12. Vacuum slits, cooling portions and cooling passages and cooling bores along with their connections and supply may be provided in the manner known from the prior art.

The calibration process may be a combination of a dry and wet calibration process, for example, or my be a totally dry calibration system. The system may also be set up so as totally to prevent any ambient air from getting at least between the extrusion tool 7 and the first calibration tool 9 and/or at least between the first calibration tool 9 and the other calibration tools 10 to 12. Naturally, it would also be possible to allow the ingress of ambient air to the article 5 or provide water baths at least in certain regions between the individual calibration tools 9 to 12.

The vacuum pressure tank 13 or 14 has a cooling chamber for the article 5 as it emerges from the calibration tools 9 to 12, in the form of a housing, illustrated in simplified format, the interior of which is divided into immediately consecutive regions by calibration plates 15, also illustrated in a simplified format. Another option is to maintain the interior of the cooling chamber at a pressure below atmospheric pressure.

On leaving the extrusion tool 7, the article 5 is of a cross-sectional shape predetermined by the latter, which is then sufficiently calibrated and/or cooled in the subsequent calibration tools 9 to 12 until the surface and peripheral regions of the brittle plastic article 5 are cooled to the degree that its external shape is stable and duly formed to the requisite dimensions. Adjoining the calibration tools 9 to 12, the article 5 is fed through the vacuum pressure tanks 13 and 14 so as to be additionally cooled and if necessary calibrated and to provide support, thereby enabling any residual heat in the article 5 to be dispelled.

For operating purposes, the extrusion plant 1, in particular the devices and apparatus provided and mounted on the calibrating table 21 are can be connected to a supply system, not illustrated in detail, by means of which a whole range of equipment may be used, for example to apply a liquid coolant, electrical power, compressed air and obtain a vacuum. A whole range of energy systems may be used and are freely selectable as appropriate.

In order to feed the article 5 through the individual calibration plates 15, the latter have at least one orifice 24, individual shaping surfaces 25 of the orifice 24 bounding and enclosing an external cross-sectional shape of the article as it is fed through, at least in certain regions.

The extrusion tool 7 mounted on and secured to the extruder 2, which is illustrated in a very simplified diagram, has a diagrammatically illustrated retaining device 26 for at least one of several die plates 27 arranged one immediately after the other in the extrusion direction 6, forming an extrusion die 28 with an inlet region 29 and an outlet region 30. The design of the retaining device 26 and the extrusion die 28 formed by the die plates 27 will be explained below with reference to the other drawings.

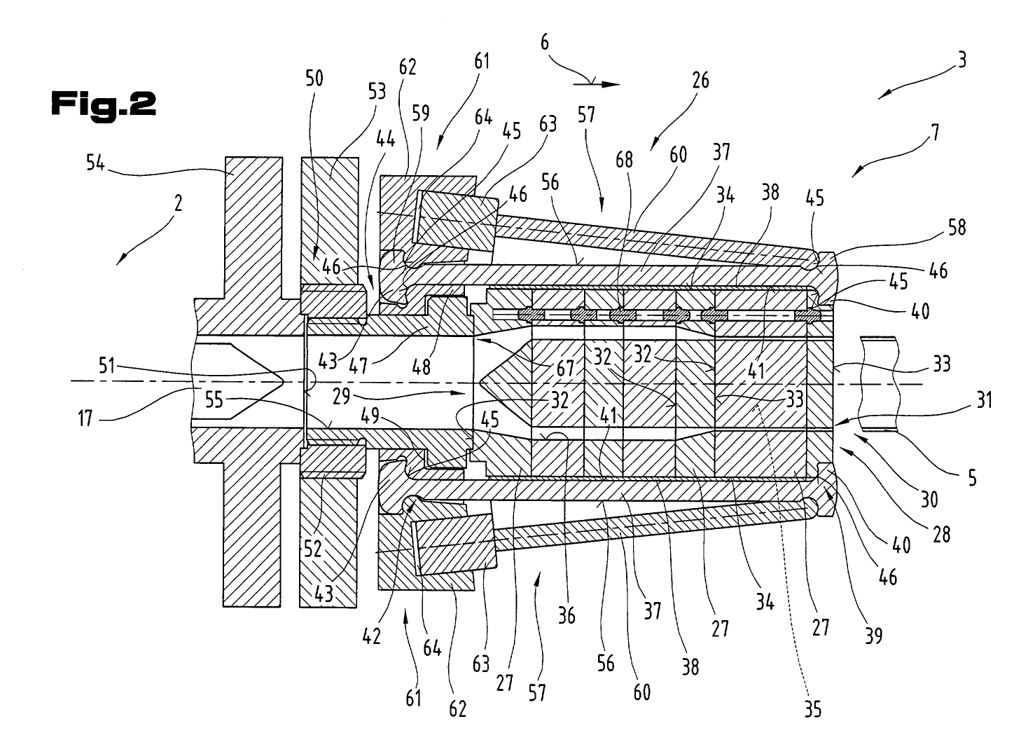

FIGS. 2 to 7 provide an illustration of the extrusion tool 7 on an enlarged scale, the same reference numbers being used for the same parts as those described in relation to FIG. 1 above. Accordingly, the extrusion tool 7 has the retaining device 26 and the extrusion die 28 made up of several die plates 27 arranged immediately one after the other.

The last die plate 27 in the extrusion direction 6 forms a die lip 31 for the emerging article 5 and simultaneously constitutes the outlet region 30. The first die plate 27 of the extrusion die 28 in the extrusion direction 6 forms the inlet region 29, the extrusion die 28 being fixed in its longitudinal extension in the extrusion direction 6. The individual die plates 27 have end faces 32, 33 directed towards one another which are applied against one another with a predeterminable minimum pressure by the retaining device 26 in the operating position, as will be explained in more detail below. The individual die plates 27 also have respective side ends 34, 35 extending between the end faces and preferably lying opposite one another. The dimensions of the individual side ends 34, 35 respectively in the direction perpendicular to the extrusion direction 6 are, for example, 100 mm×100 mm to 200 mm×200 mm, depending on the size of the section or the profiled cross section of the article 5 to be produced. These dimensions may also be square or rectangular but an approximately same external dimension in the plane perpendicular to the extrusion direction is preferred.

Due to the design of the retaining device 26, a flow passage 36 formed within the individual die plates 27 may be arranged at a relatively short distance from the side ends 34, 35, it being possible to accommodate this, as compared with conventional extrusion dies which have a smaller cross-sectional dimension transversely to the extrusion direction 6, because no tensioning elements such as connecting screws, bolts and similar have to be provided in the peripheral region between the flow passage 36 and the individual side ends 34, 35.

Co-operating with the individual die plates 27, in this instance arranged immediately one after the other, in the region of the opposing side ends 34 is at least one tension element 37 spanning the side ends 34, which extends at least between the inlet region 29 and the outlet region 30. The tension elements 37 are spaced at a distance apart from one another in the direction perpendicular to the extrusion direction 6, optionally with a tempering element 38 being connected in between, abutting with the side ends 34.

As also illustrated, a holding element 40 is provided in an end region 39 of the tension elements 37 directed towards the outlet region 30 and projects across flat faces 41 directed towards one another in the direction of the respective oppositely lying tension element 37. The oppositely lying side ends 34, 35 of the die plates 27 bound a cross-sectional surface of the die plates 27, extending in the direction perpendicular to the extrusion direction 6, the reciprocally facing holding elements 40 projecting into the cross-sectional surface bounded by the side ends 34, 35 and, in this embodiment, engaging round the side ends 34. Holding elements 43 are also provided on the other end regions 42 of the tension elements 37 co-operating with the inlet region 29, also projecting respectively across the flat faces 41, which can be actively connected to the die plate stack of the extrusion die 28 by means of a clamping mechanism 44 connected in between.

In the embodiment illustrated as an example here, a rounded piece 45 is provided in the transition region between the flat face 41 and the holding element 40 and 43, which project across the flat face 41 more or less at a right angle, the purpose of which is to prevent any impact in this transition region, which is subjected to a high degree of stress, thereby ensuring a high degree of operating safety, especially when high clamping forces are applied.

The die plate 27 assigned to the outlet region 30 of the embodiment illustrated as an example here, which co-operates with the tension elements 37 and the holding elements 40 provided thereon, has a respective radius 46 complementing the rounded piece 45 in the portions which engage and co-operate with one another. This being the case, the radius 46 may be provided in the transition region between the side ends 34 and the end face 33 of the die plate 27 directed towards the outlet region 30, it being possible, as a means of saving space and for reasons of strength, to provide a recess respectively in the two side ends 34 designed to complement the holding element 40 engaging with it. The significant point of this is that the force from the tension element 37 and hence the holding element 40 connected to it is introduced in the peripheral region or transition region between the side ends 34 and the end face 33. This being the case, the distance between the flow passage 36 and the region at which the force is introduced is selected so as to be as short as possible so that the clamping forces to be applied in the operating position and the associated abutment forces between the end faces 32, 33 directed towards one another are preferably introduced in a continuous region surrounding the flow passage 36, ensuring that a clearance-free abutment of the end faces 32, 33 can be achieved in this region. Consequently, given the high pressures prevailing in the flow passage due to the mass flow, the latter is prevented from getting between the end faces 32, 33 immediately facing one another because the force is applied immediately adjacent to the cross-sectional surface of the flow passage 36.

As also illustrated in this embodiment, the tension elements 37 project beyond the extrusion die 28 in the direction opposite the extrusion direction 6—in other words are longer than it—and the clamping mechanism 44 is disposed between the first end face 32 of the first die plate 27 in the extrusion direction 6 and the end region 42 of the tension element 37 co-operating with the inlet region 29, abutting firstly in a sealing arrangement on the first end face of the die plate 27 and secondly being supported on the holding elements 43 of the tension elements 37 and being actively connected thereto. The clamping mechanism 44 has at least one piston 47 in the form of a hollow cylinder, and a cylinder 48 co-operating therewith and arranged between the piston 47 and the tension element 37 and holding element 43.

By preference, the rounded piece 45 is provided in a transition region between the flat faces 41 of the tension elements 37 and the other holding elements 43 in the end region 42, so as to minimise or completely rule out any impact which might otherwise occur in this end region 42. In order to reduce the surface pressure and ensure safe abutment, the portions of the cylinder 48 assigned to the holding elements 43 and co-operating with them are designed with a radius 46 complementing the rounded piece 45. The rounded pieces 45 respectively co-operating with the radii 46 may be identical in the two end regions 39, 42 of the tension elements 37 and/or of a different design. This is freely selectable in a manner known from the prior art, depending on the forces to be absorbed and the geometric relationships.

As described above, the clamping mechanism 44 in the embodiment illustrated as an example here is provided in the form of a cylinder-piston arrangement, consisting of the piston 47 and the cylinder 48. The cylinder 48 of the clamping mechanism 44 is actively connected to the two holding elements 43 of the tension elements 37 assigned to the inlet region 29, in particular being supported thereby.

When the retaining device 26 is in the operating position illustrated in FIG. 2, a cylindrical chamber 49 is formed between the cylinder 48 and the piston 47 as illustrated in a simplified, schematic form, various delivery and discharge lines and the requisite sealing elements freely selectable from the prior art being used, although these have been left out of the diagram in order to provide better clarity. This cylindrical chamber 49 may be filled with pressuring medium, the pressures applied at this point being between 200 and 3000 bar, preferably between 500 bar and 1500 bar, in order to apply the requisite clamping forces. To preserve clarity in the drawings, the supply unit for the pressurising medium and the details of the sealing system for the pressure units, which will be described in more detail later, have been left out of the drawings for the sake of clarity, but may be freely selected from the means known from the prior art.

The piston is fixedly connected to the extruder 2 by means of a schematically illustrated connecting device 50, the end of the piston 47 facing an outlet 51 of the extruder 2 having a threaded ring 52, for example, screwed on its outer periphery, likewise having another thread on its outer periphery onto which an adjusting ring 53 can be screwed. A flange 54 on the extruder 2 co-operates with this adjusting ring 53 and the adjusting ring 53 is fixedly retained on the flange 54 and hence on the extruder 2 by fixing means not illustrated. As a result, the piston 47 is held positioned in its stationary fixed relative to the extruder 2.

The individual die plates 27 arranged one after the other are spanned at their external faces—in this instance at their side ends 34—by the tension elements 37 when in the operating position, aligned parallel with one another and parallel with the extrusion direction 6, and are applied in a sealing arrangement, by means of the holding elements 40 and the pressure generated in the cylindrical chamber 49 by the co-operating cylinder 48, against the extrusion direction 6 on to the piston 47. This being the case, the clamping mechanism 44 is disposed between the tension elements 37 and the die plates 27 of the extrusion die 28 co-operating operating with them, although it would also be possible for the clamping mechanism 44 to be arranged in the outlet region 30 between the die plate 27 and the tension elements 37. The piston 47 also has another orifice 55, which is in flow communication with the flow passage 36 via the outlet 51 of the extruder 2.

The tension elements 37 illustrated here are provided in the form of at least one plate- or bar-shaped component, having a longitudinal extension in the extrusion direction 6 which is longer than a length of the extrusion die 28 co-operating therewith. The plate-shaped tension element or elements 37 with the holding elements 40, 43 mounted thereon are subjected to a high degree of tension in the operating position, the force being transmitted by the holding elements 40, 43 projecting above the flat faces 41 eccentrically to the neutral zone of the plate- or bar-shaped component. Consequently, it may be necessary to provide rib- or fin-shaped stiffening elements, not illustrated in detail, on the side remote from the first flat faces 41 and the extrusion die 28—in other words in the region of other flat faces 56—in order to prevent and avoid any associated inadmissible deformation of the tension elements 37.

In addition to the clamping mechanism 44 co-operating with the tension elements 37 in this instance, the latter are also provided respectively with a pressure system 57 on their opposing faces, which preferably extends between the two end regions 39, 42 of the tension elements 37, spaced at a distance apart from one another in the extrusion direction 6, and is actively connected thereto, in particular supported thereby. To this end, at least at one but preferably at the two end regions 39, 42, the tension element 37 has a supporting element 58, 59 projecting above the other flat face 56 on the side remote from the extrusion die 28. The holding element 40, 43 and the supporting element 58, 59 has a hook-shaped cross section in the direction of the longitudinal extension and in a plane perpendicular to the flat faces 41, 56 of the tension element 37. Viewed together, the holding elements 40, 43 and the support element 58, 59 arranged on the end regions 39, 42 have a hammer-shaped cross-section projecting above the flat faces 41, 56 in the direction of longitudinal extension and in a plane perpendicular to the flat faces 41, 56 of the tension element 37. This being the case, it is of advantage, as described above in respect of the transition region between the flat faces 41 and the holding elements 40, 43, if a rounded piece 45 is also provided or arranged in the transition region between the flat faces 56 and the supporting elements 58, 59.

The individual pressure systems 57 respectively have at least one pressure element 60 as well as a pressure generator 61 actively connected thereto. The pressure element 60 is preferably provided in the form of a plate- or bar-shaped component and is supported on the supporting element 58 on the side facing the outlet region 30 and preferably has a radius 46 complementing the rounded piece 45.

In the embodiment illustrated as an example here, the pressure system 57 extends at an angle to the tension element 37, the two pressure systems 57 converging with one another in the extrusion direction 6 or from the inlet region 29 to the outlet region. The pressure generator 61 in this embodiment has a cylindrical housing 62, which co-operates with the tension element 37 and the supporting element 59 mounted thereon arranged adjacent to the inlet region 29, and at least one ram 63 disposed in the cylindrical housing 62.

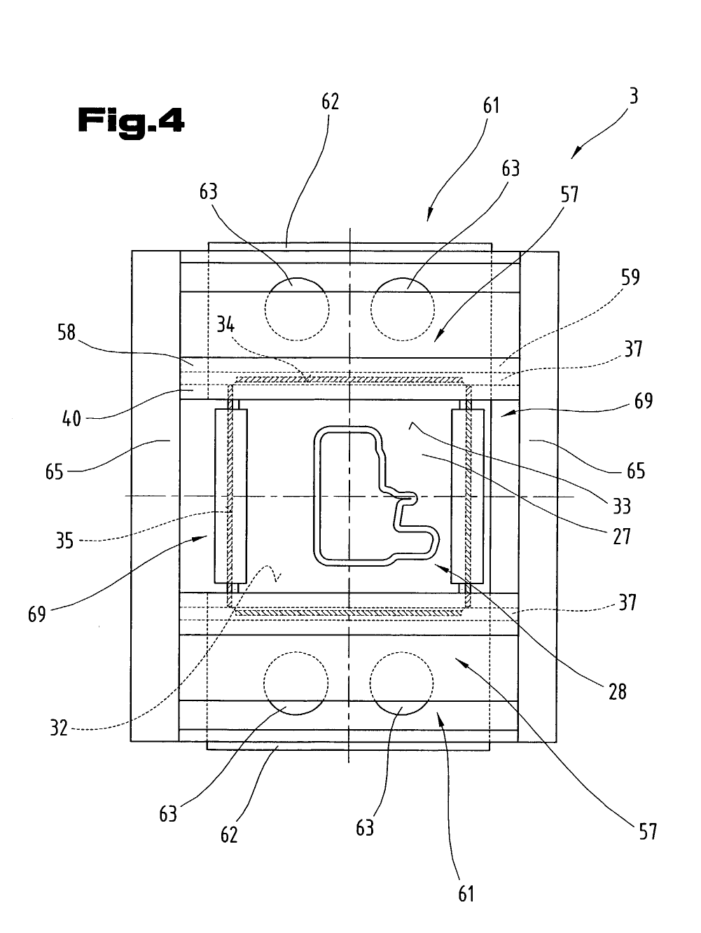

As may be seen more clearly from FIG. 4, it may be of advantage to provide several but preferably two rams 63 in each of the cylindrical housings 62, supported on the pressure element 60, and pressurising medium is applied by means of lines, not illustrated, to a cylindrical chamber 64 or cylindrical chambers 64 between the cylindrical housing 62 and the ram or rams 63, thereby enabling a pressurising force to be introduced into the pressure elements 60 in the direction of arrow F. If a pressure of approximately 1300 bar, for example, is applied to the active cylinder surface via the clamping mechanism in the cylindrical chamber 49, this will lead to a tension force and an active clamping force inside the tension elements 37 on the individual die plates 27 of 300 kN per tension element 37. In order to obtain a centred tension force of the tension element 37, it is of advantage to introduce a force of 300 kN to the pressure element 60 via the pressure generator 61 as well, so that each of the tension elements 37 has a tension force of 600 kN applied to it. These figures are merely given by way of example and the requisite surface pressure around the flow passage 36 between the mutually facing end faces 32, 33 can easily be fixed and varied depending on the clamping force to be applied, based on the internal pressure prevailing in the flow passage 36.

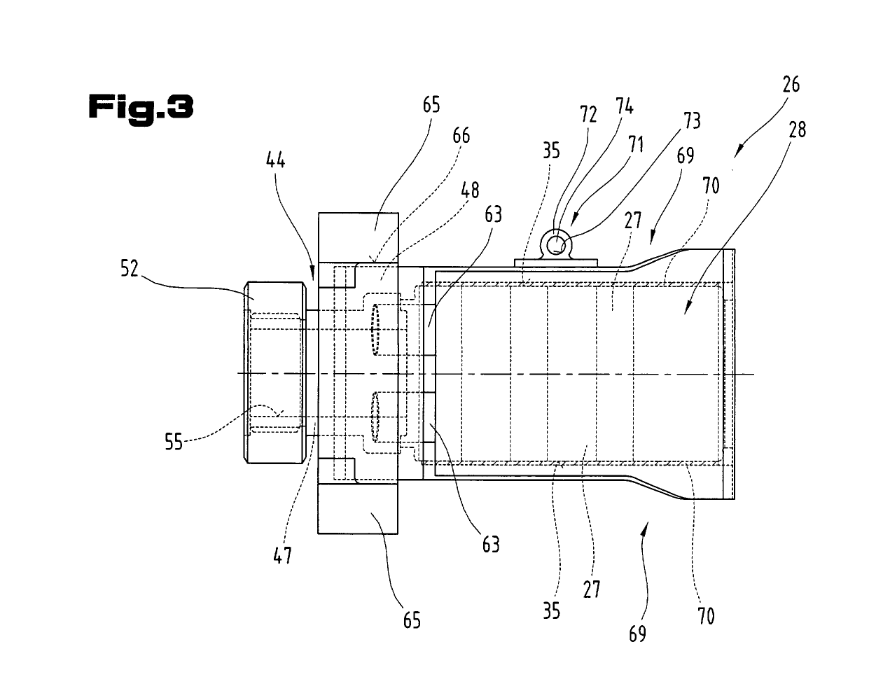

The cylindrical housing 62 of the pressure generator 61 is supported on the supporting element 59 directed towards the inlet region 29. Likewise, it is of advantage if the portions of the cylindrical housing 62 respectively co-operating with the transition region between the tension element 37 and the supporting element 59 also have the radius 46 described above in the region of the cylindrical housing 62 and the complementing rounded piece 45 in the region of the tension element 37. In order to obtain a mutual fixed position of the two cylindrical housings 62 of the pressure generators 61 spaced at a distance apart from one another, it is of advantage if these cylindrical housings 62 are respectively joined to one another in a fixed arrangement, in particular by a bar-shaped retaining element 65 on the side remote from the clamping mechanism 44. This is most clearly seen in FIGS. 3 and 4. In addition, the cylinder 48 of the clamping mechanism 44 may also have side faces 66 directed towards the two retaining elements 65 and designed to abut in a sliding arrangement therewith. This provides a guiding action during displacement of the cylinder 48 relative to the fixed piston 47.

In order to apply the above-mentioned tension and pressure forces, it is of advantage if the cylindrical chamber 49 of the clamping mechanism 44 is connected by a line to the cylindrical chamber or chambers 64 of the individual pressure generators 61. In addition, the sum of the active piston surfaces of the rams 63 of the individual pressure generators must be the same as and/or greater than the active cylinder surface of the cylinder 48 of the clamping mechanism 44. As a result of the line connection and the size of the piston surfaces to be adjusted relative to one another, a predeterminable force can always be introduced into the individual pressure systems 57 and the clamping mechanism 44 and hence the tension elements 37, provided the same pressure is applied. The individual delivery and discharge lines and any connecting lines which might be provided to the individual cylindrical chambers 49, 64 have been left out of the drawings in order to retain clarity. The same applies to the individual units for supplying the pressurising medium.

To temper the individual die plates 27 of the extrusion die 28, the tempering element 38 in this embodiment is provided, in particular fixedly mounted respectively on at least certain regions of at least one but preferably the two mutually facing flat faces 41 of the tension elements 37.

As may also be seen from comparing FIGS. 2 and 4, the individual die plates 27 have a cross-sectional surface in a plane perpendicular to the extrusion direction 6, which is preferably bounded by the respective mutually parallel side ends 34, 35. This being the case, the tension element 37 and the holding element or elements 40, 43 mounted thereon and optionally the supporting element or elements 58, 59 have a width perpendicular to the longitudinal extension, which more or less corresponds to a length of the side ends 34, 35 of the die plates 27 co-operating with the tension elements 37 in the same direction. As a result, the clamping and retaining forces are introduced into the individual die plates 27 starting from the peripheral regions in the direction of the flow passage 36. In this example, these forces are introduced from both the opposing side ends 34, as a result of which a sufficient surface pressure and hence a secure abutment of mutually facing end faces 32, 33 is guaranteed in the region of the flow passage 36, including during operation. The significant aspect of this is that the shaping system 3 with the individual die plates 27 arranged one after the other to form the extrusion die 28, the mutually facing end faces 32, 33 sit abutment with one another by means of a predeterminable minimum pressure, at least over a part-region of the end faces 32, 33 in the region of the flow passage 36, including when the mass flow passes under pressure through the flow passage 36, calculated on the basis of the mass pressure accumulated by the plastics material in the flow passage 36 plus a supplementary value of approximately 20%. At a mass pressure of 350 bar, for example, this gives a minimum contact pressure of 420 bar in this region.

This being the case, it is necessary for this predeterminable minimum pressure to be applied continuously around the entire circumference of the flow passage 36 during operation of the extrusion die 28 between the mutually abutting end faces 32, 33. The abutment region surrounding and bounding the flow passage 36 must not extend beyond the full extension of the end faces 32, 33 but may decrease in the direction of the side ends 34, 35 externally bounding the die plates 27 and in the event of a potential deformation of the individual die plates 27 during operation, the contact force may fall to a value of 0.

It is also of advantage to provide a centring arrangement 67 between the piston 47 of the clamping mechanism 44 and the end face 32 of the first die plate 27 directed towards the inlet region 29. This will firstly ensure exact positioning relative to the retaining device 26 and the orifice 55 inside the piston 47 when a die is changed from a first to another extrusion die 28. Secondly, care must be taken to ensure that in the contact region between the first end face 32 of the die plate 27 and the piston 47 is a flat contact to ensure that softened plastics material is prevented from getting between the mutually facing faces. Ingress of the softened plastics material is prevented by the minimum pressure applied around the circumference of the flow passage 36, which prevents burning, too long a dwell time inside the extrusion die 28 and thus any detrimental effect which the overall mass flow might otherwise have.

The mutual alignment of the individual die plates 27 one after the other and the resultant stepless transition of the flow passage 36 from one to the immediately adjacent die plate 27 is obtained by providing individual centring elements 68, illustrated in simplified schematic form, and respectively projecting into mutually facing end faces 32, 33. These centring elements 68 may be bolts, for example, conical centring pins and variable or adjustable catch elements of the type known from the prior art.

As may also be seen from comparing FIGS. 3 and 4, when the extrusion die 28 is in the operating position, a schematically illustrated pre-tensioning mechanism 69 is assigned to the region of the other side ends 35—in other words in this instance the lateral or perpendicularly aligned side ends 35 of the die plates 27. The purpose of this pre-tensioning mechanism 69 is to hold the stack of die plates 27 arranged one after the other mutually aligned with one another in the extrusion direction 6 by means of the centring elements 68, in a predeterminable position, until the entire extrusion die 28 has been clamped against the piston and on the extruder by the retaining device 26 with the minimum clamping force. In this case, the pre-tensioning mechanism 69 is able to co-operate with only one of the two side ends 35 but preferably co-operates with the two opposing side ends 35.

Another option is to provide the pre-tensioning mechanism 69 with at least one tempering element 70, which preferably sits in abutment at least in certain regions with the side ends 35 of the die plates 27. Consequently, heat can be applied to the die plates arranged immediately one after the other in the pre-tensioning mechanism to enable a rapid die change, which will be explained in more detail below. The tempering elements by be electric heating elements, heat radiators etc., known per se from the prior art. The important factor is that the individual die plates 27 can be thoroughly heated to a predeterminable temperature above ambient temperature, for example to 200° C. This enables a rapid die change.

As explained above, the pre-tensioning mechanism 69 described above co-operating with the side ends 35 and engages over the entire length of the extrusion die 28 made up of the individual die plates 27. Consequently, the pre-tensioning mechanism 69 extends between the inlet region 29 and the outlet region 30 and the pre-tensioning mechanism 69 may have similarly designed holding elements at both end regions, as described earlier with regard to the holding elements 40, 43 provided for the tension elements 37. However, in view of the significantly lesser amount of force which needs to be applied, these holding elements may be of smaller dimensions than those of the tension elements 37. Likewise, a rounded transition and a complementing radius may be provided as described above in respect of the rounded piece 45 and radius 46.

Although illustrated in a simplified schematic manner only in FIG. 3, at least one supporting element 71 co-operates with the die plates 27 of the extrusion die 28, which may be linked to a die changing system by means of a pivoting mechanism not illustrated in detail but which will be described more specifically with reference to the next drawing. In the embodiment illustrated as an example here, however, the supporting element 71 is fixedly joined to one of the pre-tensioning mechanisms 69. This being the case, the supporting element 71 is arranged in the longitudinal direction of the extrusion die 28, to the side thereof, more or less in the half length, an exact fixed positioning being obtained by means of the pivoting mechanism of the die-changing mechanism to be explained in more detail below. By preference, however, a position is selected in which the extrusion die 28 exerts only a slight pivoting moment due to the uniform load distribution between inlet region 29 and outlet region 30 on the supporting element 71. A support part 72 of the supporting element 71 has an orifice 73 of a preferably circular design, in which a connecting part 74 can be inserted. This connecting part 74 permits a pivoting or rotating motion in a horizontal plane if the orifice 73 is circular in shape and the process of changing the die can be significantly shortened once the extrusion die 28 is released.

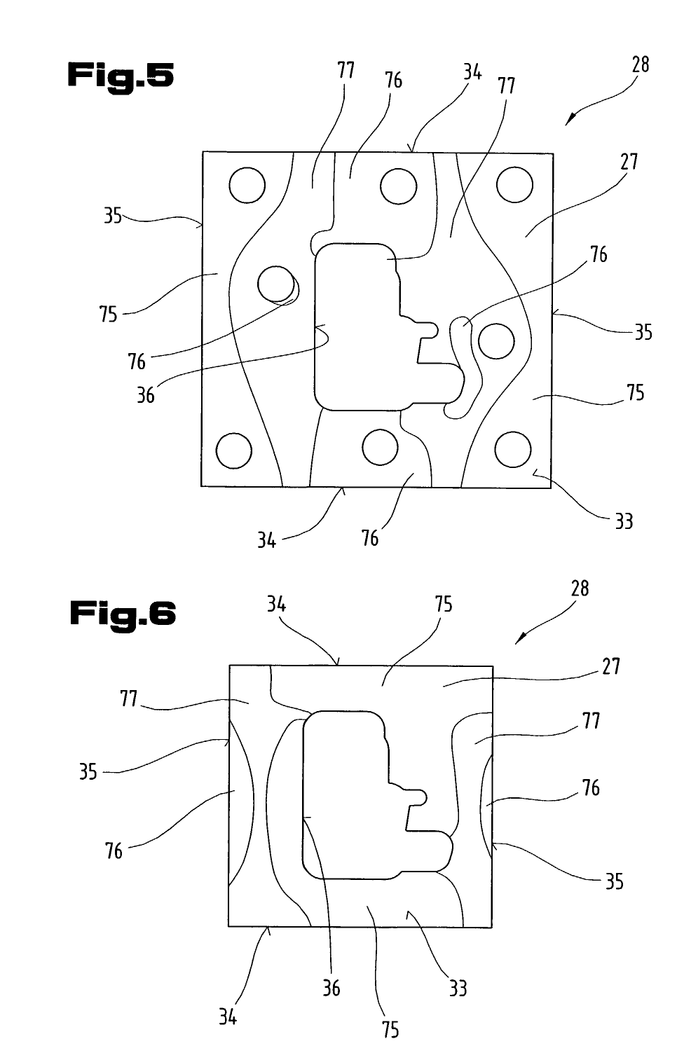

Both FIGS. 5 and 6 illustrate respectively two individual die plates 27, which are arranged in a same position within an extrusion die 28. The die plate 27 illustrated in FIG. 5 is held together to form an extrusion die 28 by conventional retaining means such as screws to tighten the die plates 27, the distribution of force and pressure on the end face 33 being illustrated in simplified form. FIG. 6, on the other hand, provides a simplified illustration of the force and pressure distribution obtained on the end face 33 by the retaining device 26 proposed by the invention.

As may be seen form FIG. 5, a schematically simplified zone 75 may be seen extending in the outer peripheral region of the end face 33, directed towards the side ends 35, in which the tensioning pressures in excess of 300 bar are produced by the existing known screw connections. In other zones 76, which extend in certain regions as far as the flow passage 36, the clamping pressure on the end face 33 falls to a value of 0, as a result of which the softened plastics material from the molten flow is able to get between the mutually facing end faces 32, 33. In other zones 77, running between zones 75 and 76 described above, pressures of a value between 0 to 300 bar prevail.

Turning to FIG. 6, the retaining device 26 proposed by the invention applies a pressure to the end face 33 around virtually the entire circumference of the flow passage 36, which is higher than a pressure of 300 bar. Zones 76 are indicated respectively in the region of the opposing side ends 35, where the pressure on the end face 35 has a value of 0. The other zone 77 is disposed between the two zones 75 and 76, which spreads as far as the flow passage 36 in small part regions only but a pressure value in excess of 200 bar is in any event generated in the region of the flow passage 36 in this embodiment and decreases towards the side ends 35. Consequently a full and above all sealing contact is guaranteed between the two mutually facing end faces 32 and 33.

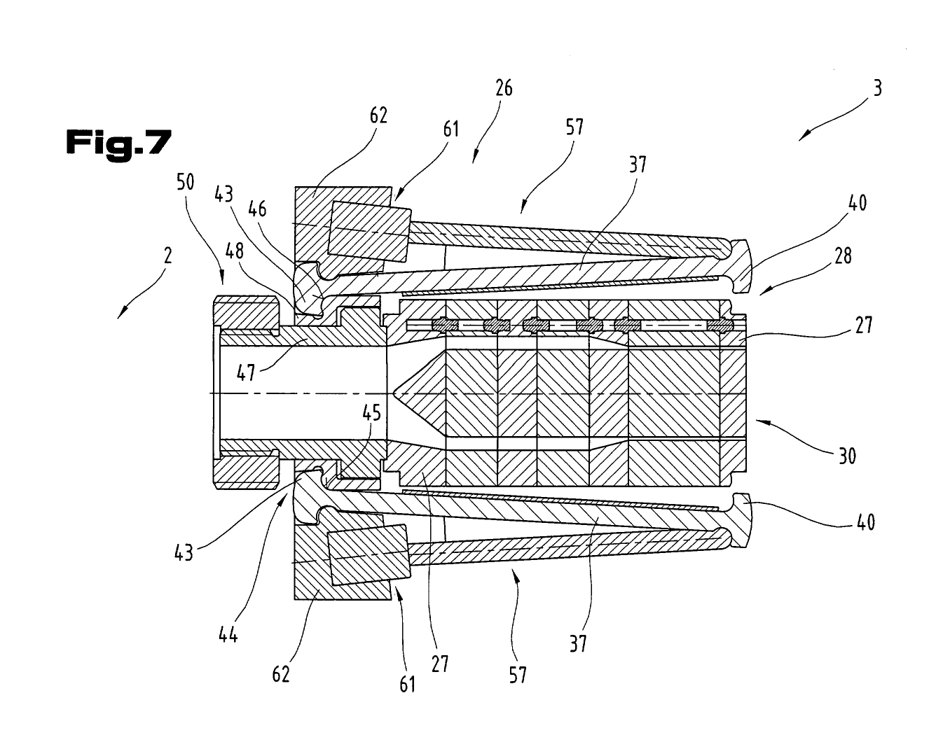

FIG. 7 shows the shaping system 3 with the retaining device 26 and the extrusion die 28 comprising die plates 27 arranged one after the other with the retaining device 26 in a release position, in which the two tension elements 37, in particular the holding elements 40 arranged thereon in the outlet region 30, are not in engagement with the extrusion die 28. Accordingly, the two tension elements 37 effect a pivoting movement in the region of the cylinder 48 of the clamping mechanism 44, in particular the radius 46 on the cylinder 48 and the rounded piece 45 between the flat face 41 and the holding element 43. Moreover, almost all of the pressurising medium is forced out of the cylindrical chamber 49, as a result of which the entire extrusion die 28 is released, enabling the extruder 2 to be removed. The two pressure systems 57 are likewise without pressure, making the releasing movement possible.

The advantage of this embodiment of the retaining device 26 described above is that a certain lengthwise tolerance of the individual die plates 27 arranged one after the other can be compensated by the clamping mechanism 44 in conjunction with the tension elements 37 because these tolerances can be compensated by the displacement path of the cylinder-piston arrangement. Because the two cylindrical housings 62 are connected by the two holding elements 65 and the cylindrical housing 62 is supported on the tension element 37 as described above, these parts are displaced with the tension element relative 37 to the stationary piston 47. Other manufacturing tolerances are compensated by the co-operation of the cylindrical housing 62 with the rams 63. Consequently, a uniform force is always transmitted from the tension elements 37 to the extrusion die 28.

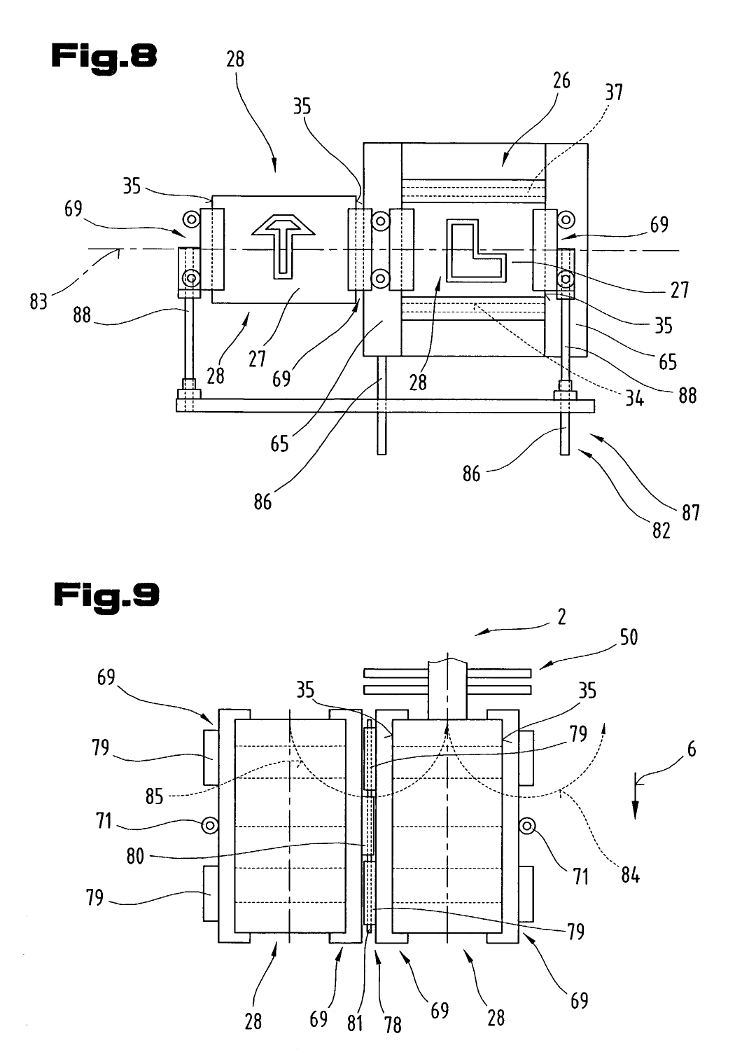

FIGS. 8 and 9 provided a simplified diagram of two extrusion dies 28 disposed adjacent to one another, in this instance horizontally, one of which is held stationary on the extruder 2 by the retaining device 26, although the latter is shown in FIG. 8 only in order to preserve clarity. To avoid unnecessary repetition, reference may be made to the more detailed description above relating to FIGS. 1 to 7, the same reference numbers being used to denote the same parts.

The extrusion die 28 illustrated on the right-hand side of the two drawings is illustrated in the so-called operating position, i.e. it is held stationary on the extruder 2 by means of the retaining device 26. The other extrusion die 28 illustrated on the left-hand side of the two drawings is aligned parallel with the first extrusion die 28, immediately adjacent to it in the region of the side end 35. Accordingly, the pre-tensioning mechanism 69 co-operates respectively with the two extrusion dies 28 in the region of the side ends 35, holding the die plates 27, which would otherwise be loose, in abutment with one another in their pre-centred position.

Also provided on the mutually facing side ends 35 of the two extrusion dies 28, between the pre-tensioning mechanisms 69 disposed there, is a coupling mechanism 78, by means of which the extrusion die 28 illustrated on the left in this instance can be held in position against it, thereby permitting the adjusting motion jointly with the extrusion die- 28, shown in the operating position, to be effected as described below. The coupling mechanism 78 may be of any design and in this particular instance consists of coupling elements 79, 80 offset from one another on the clamping pre-tensioning mechanism 69 and arranged stationary thereon. Turning to the extrusion die 28 illustrated on the left-hand side, it is clear from FIG. 9 that the two coupling elements 79 are arranged spaced apart from one another in the extrusion direction 6 and are provided in the form of tubular components, for example. The other coupling element 80 is disposed on the right-hand side of the extrusion die 28 but is centred between the two coupling elements 79 on the left-hand side on the pre-tensioning mechanism 69, as a result of which the a locking element, such as a bolt for example, can be pushed in to the coupling elements 79, 80 aligned flush with one another, thereby providing a simple reciprocal holding means.

A die changing mechanism 82 is also illustrated in simplified form on the retaining device 26 underneath the extrusion die 28, which is in the operating position, by means of which the first extrusion die 28, shown in the operating position, can be released from this operating position by the retaining device 26 into the removal position and the other extrusion die 28 moved from its preparation position into the operating position. The pivoting movement described above is effected in a horizontal pivot plane 83, which is schematically indicated in FIG. 8. This pivot plane 83 is also parallel with the tension elements 37 in their operating position, readily enabling a lateral pivoting action or displacement in this plane.

An arc 84 or 85 is schematically indicated in broken lines in FIG. 9, describing the pivoting movement of the two extrusion dies 28 coupled with one another in the pivot plane 83.

In the embodiment illustrated as an example here, the die-changing mechanism 82 has two guide posts 86 arranged transversely to the extrusion direction and perpendicular to the pivot plane 83, and in this instance are fixedly mounted on the two holding elements 65 of the retaining device 26. A pivoting mechanism 87 is mounted on these guide posts 86 and may be slidable if necessary. Consequently, the other die 28 in the preparation position can be received by a transport means, not illustrated in detail, and the prepared extrusion die 28 lifted by means of this pivoting mechanism 87, a displacement being effected relative to the guide posts 86 and the other extrusion die 28 immediately adjacent to the first extrusion die 28 in its operating position and retained thereon by means of the coupling mechanism 78 described above.

By means of the two supporting elements 71 arranged on the side ends 35 of the two extrusion dies 28 remote from one another, the extrusion dies 28 also joined thereto can be mounted so as to rotate or pivot about pivot pins 88 disposed vertically or perpendicular to the pivot plane 83. Consequently, the two coupled extrusion dies 28 can be moved jointly and simultaneously, the prepared extrusion die 28 being mounted so as to rotate or pivot in the pivot plane 83 about the pivot pin 88 into any position before the coupling procedure. The design of the die-changing mechanism 82 will be described in more detail with reference to the next drawings.

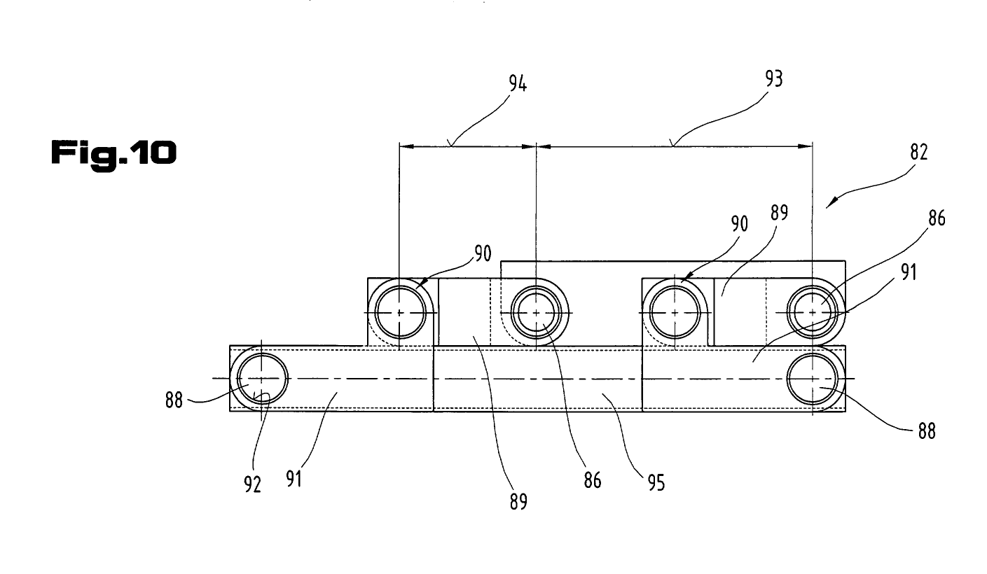

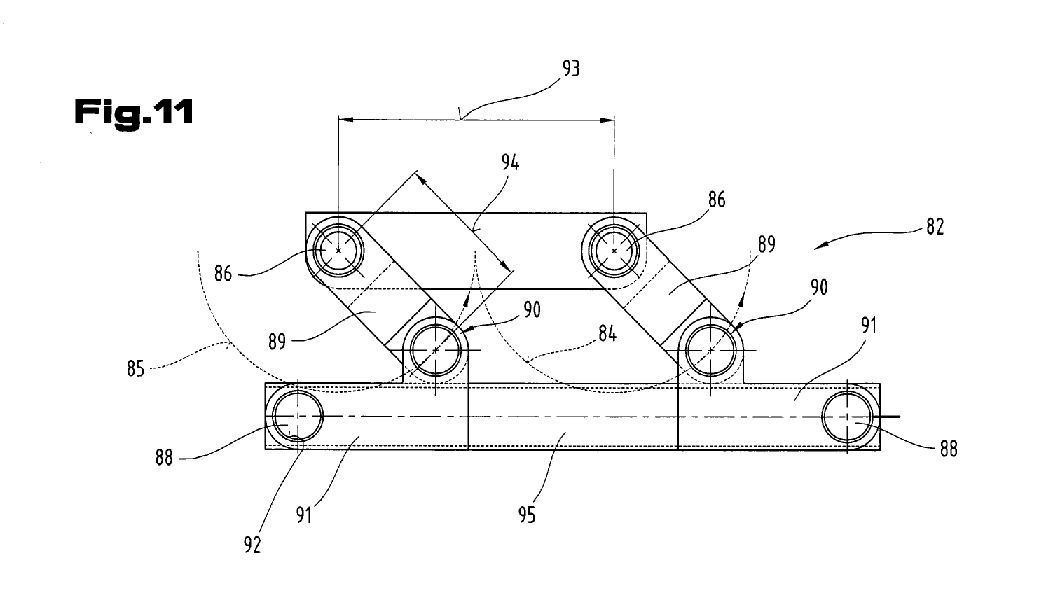

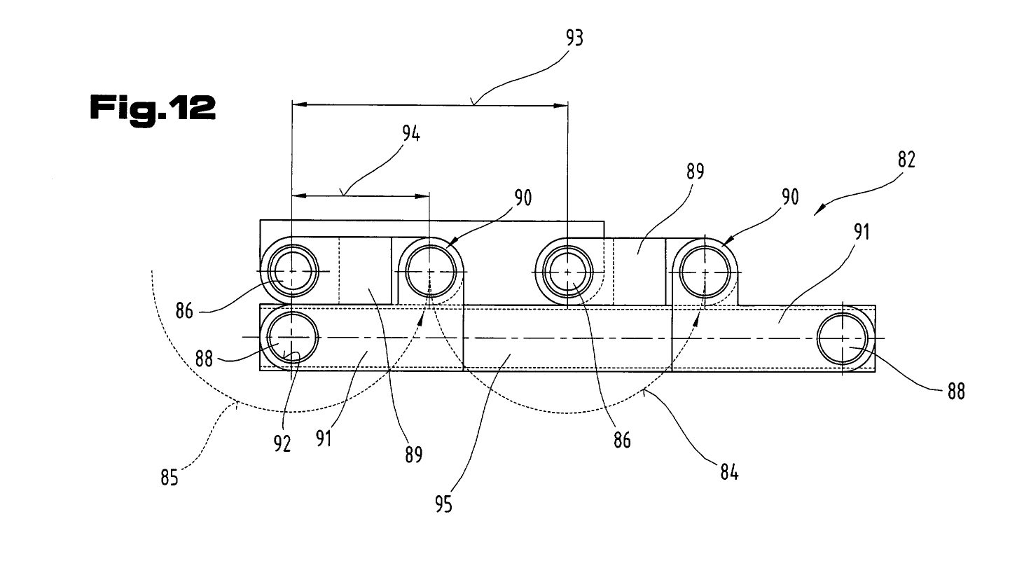

FIGS. 10 to 13 provide diagrams of the die-changing mechanism 82 on a larger scale and in different positions. The same reference numbers are used to denote the same parts as those described above in respect of FIGS. 1 to 9 and reference may be made to this part of the description to avoid unnecessary repetition.

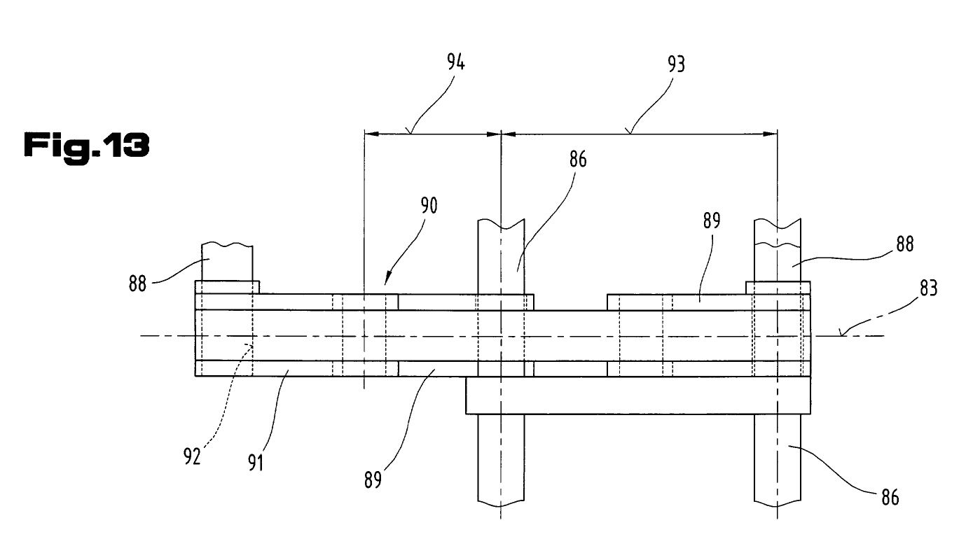

The die-changing mechanism 82 is mounted so as to be displaceable along the guide posts 86 illustrated in a simplified form, vertically or perpendicular to the pivot plane 83, as necessary. Pivot arms 89 are mounted on the guide posts 86 at a distance apart from one another so as to be slideable in the direction of the guide posts 86 and so as to pivot about them. A bearing arrangement 90 is provided respectively on the end region of the pivot arms 89 remote from the guide posts 86, about which bearing arms 91 are pivotably mounted in a parallel alignment with the guide posts. In this particular example, these bearing arms 91 form a more or less L-shaped arrangement, a receiving orifice 92 being provided on the end region of the bearing arms 91 remote from the bearing arrangement 90 for the pivot pin 88 illustrated in a simplified form in FIG. 13.

A distance 93 between the two mutually parallel guide posts 86 corresponds to double a space 94 between the centre of the guide post 86 and the centre of the bearing arrangement 90. This space 94 simultaneously also constitutes the radius of the arc 84, 85, in which the two extrusion dies 28 (see FIG. 8)can be pivoted in the pivot plane 83 relative to the extruder 2 (see FIG. 9). The two extrusion dies 28 are held on the die-changing mechanism 82 firstly by means of the pivot pins 88 inserted in the bearing elements 71 (see FIG. 9) and secondly by means of the latter and the receiving orifice 92 on the bearing arms 91. The two bearing arms 91 are in turn linked to the pivot arms 89 so as to articulate about an axis of the bearing arrangement 90 parallel with the guide posts 86. It is also of advantage if the two bearing arms 91 are coupled with one another by a common connecting element 95, in particular rigidly connected to one another, since this will provide a strong means of preventing any rotation of the two bearing arms 91 relative to the alignment with the guide posts 86 when receiving the extrusion dies 28.

The retaining device 26 enables at least one extrusion die 28 comprising several die plates 27 arranged immediately one after the other to be held on an extruder 2, whereby the clamping forces to be applied in the operating position are transmitted to the individual die plates 27 by at least two oppositely lying tension elements 37, which span the extrusion die 28 at its side ends 34 and/or 35 from the exterior and project into the cross-sectional surface of the individual die plates 27 formed or bounded by the side ends 34, 35 at the respective inlet region 29 and outlet region 30 of the extrusion die 28, and by holding elements 40, 43 engaging round these side ends 34, 35.

Another advantage is the build-up to the quick and rapid changing of different designs of extrusion dies 28 on an extruder 2, whereby heat can be applied to another extrusion die 28 made up of several die plates 27 arranged one after the other in its preparation position. This may take place immediately adjacent to the extruder 2 during operation, for example, the heat being applied by means of the tempering or heating elements described above. By preference, before the start of the die change, the other extrusion die 28 immedi- ately adjacent to the first extrusion die 28 is retained on the latter. When the die change is to be operated, the extruder 2 is stopped, in particular abruptly, for example using the Emergency Stop system, after which the first extrusion die 28 in the operating position is released by the retaining device 26 and the released first extrusion die together with the mass flow of softened plastics material located in it is lifted more or less in the extrusion direction 6 away from the outlet 51 of the extruder 2. This takes place on the semi-circular displacement path described above.

As a result of this slight lifting movement, the halted mass flow between the outlet 51 from the extruder 2 and the inlet region 29 to the extrusion die 28 is slightly stretched or expanded and then the mass flow in this stretched or expanded position is cut, this being followed by the displacement towards the removal position. As soon as the first extrusion die 28 has been moved out of the retaining device 26, the other extrusion die 28 is moved from its preparation position into the release position inside the opened retaining device 26 and the extrusion die 28 is then held stationary on the extruder 2 by means of the retaining device 26. As a result of the short changeover time of about 5 sec. to 20 sec., for example, the time which is then needed to prepare the plastics material by kneading inside the extruder can also be shortened. The subsequent preparation time, particularly if the material is PVC, is a multiple of the downtime for every second of down time of the extruder. As a result of the ratio described above, a very short down time of the extruder can be achieved in order to minimise non-productive periods during the die changeover.

It may also be of advantage, immediately prior to positioning the other extrusion die 28 on the extruder 2, to cut the mass flow still emerging from the extruder, which will continue to be forced through the outlet 51 and orifice 55 of the piston 47 due to the internal pressure prevailing in the extruder. This would otherwise prevent the end face 32 of the inlet region 29 from being placed in a flat and secure abutting arrangement and centred by means of the centring arrangement 67 because there would still be plastics material in between. Since the extrusion dies 28 are coupled with one another, the two extrusion dies 28 can be displaced simultaneously, thereby saving a lot more extra time.

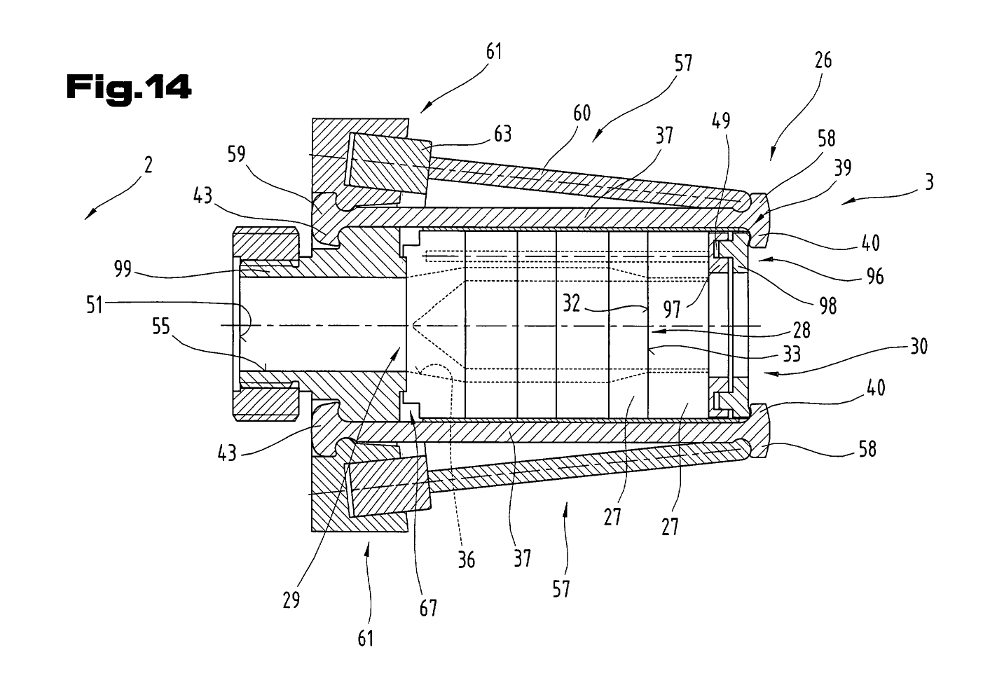

FIG. 14 illustrates another possible and optionally independent embodiment of the shaping system 3 with a retaining device 26, the same reference numbers again being used to denote the same parts as those described in the earlier drawings. Again, to avoid unnecessary repetition, reference may be made to the description of the preceding drawings.

In principle, the design of the extrusion die 28 and the retaining device 26 correspond to the embodiment described with reference to FIGS. 2 to 4 and 7 but in this embodiment, another clamping mechanism 96 is provided between the individual tension elements 37 and the extrusion die 28 in the outlet region 30 between the end face 33 of the last die plate 27 and the end regions 39 of the tension elements 37, in particular the holding elements 40.

This clamping mechanism 96 is again provided in the form of a cylinder-piston arrangement, a cylinder 97 being provided to accommodate a piston 98, between which the cylindrical chamber 49 is formed. As described above, between the piston 47 and the cylinder 48 (see FIG. 2), the pressurising medium can be introduced into this cylindrical chamber 49 and a corresponding pressure force applied to the stack of die plates 27 in co-operation with the tension elements 37 whilst the holding elements 40, 43, if any are provided thereon, can be pushed towards one another as described above.

In order to hold the extrusion die 28 and the transition between it and the outlet 51 of the extruder 2, not illustrated in detail here, a transition part 99 may also be provided, in which the orifice 55 is arranged, as described above in relation to the piston 47 (see FIG. 2). The centring arrangement 67 may be provided between the transition piece 99 and the first die plate 27 disposed at the inlet region 29, to enable the flow passage 36 to be mutually aligned with the orifice 55. In its region facing the holding element 43, the transition part 99 is of a design complementing the latter, which may be similar to that already described above with regard to the cylinder 48 (see FIG. 2) of the clamping mechanism 44.

The pressure system 57 on the side of the tension elements 37 remote from the extrusion die 28 described above may be of the same design as that described in the previous drawing, and reference may be made to this part of the description for more details.

The important factor, however, is again that the sum of the active piston surfaces of the rams 63 co-operating with the pressure system 57 should be the same as the active cylinder surface of the clamping mechanism 96. This enables force to be introduced uniformly from the tension elements 37 and the holding elements 40, 43 provided thereon, in co-operation with the transition part 99 and the clamping mechanism 96, to the individual die plates 27 arranged one after the other.

Naturally, however, it would also be possible to combine the clamping mechanism 96 described here with the clamping mechanism 44 described above with reference to FIGS. 2 to 4 and 7 and force the individual die plates 27 together into a unit forming an extrusion die 28 with these two clamping mechanism 44 and 96.

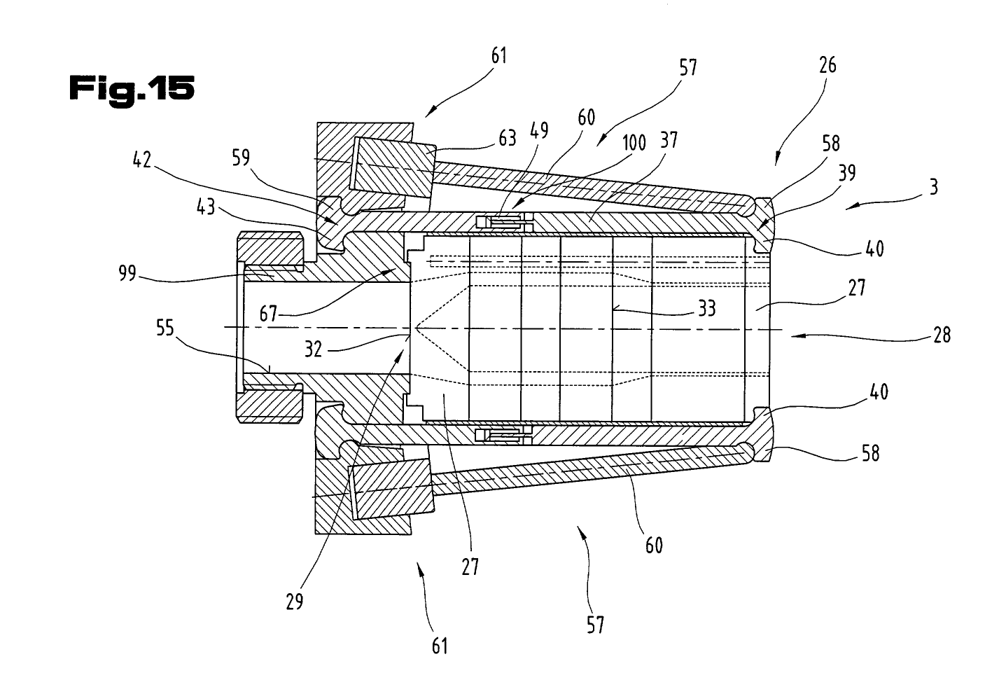

FIG. 15 illustrates another and optionally independent design of the retaining device 26, in particular the clamping mechanism 100 thereof, the same reference numbers again being used for the same parts described above with reference to FIGS. 1 to 14. Reference may be made to the description of these drawings, to avoid unnecessary repetition.

In the outlet region 30, the retaining device 26 and the extrusion die 28 correspond to the embodiment described with reference to FIGS. 2 to 4 and 7. The inlet region 29 may be of the same design as that described with reference to the transition part 99 in FIG. 14. This transition part 99 complements the arrangement of the tension element 37 and the holding element 43 provided thereon in their common engagement region. The centring arrangement 67 is again provided between the transition part 99 and the first end face 32 of the first die plate 27 in the extrusion direction 6.

The clamping mechanism 100 in this embodiment is provided between the two end regions 39, 42 within the tension elements 37, where a cylinder-piston arrangement illustrated in simple format is provided in the component forming the tension element 37. The pressurising medium needed to generate pressure for the clamping force to be applied is introduced in a manner not illustrated into the cylindrical chamber 49, the active piston surface again matches the active piston surfaces of the pressure system 57, in particular the rams 63. As a result of this mutual match, the tension elements 37 are prevented from tilting relative to the extrusion die 28, ensuring that forces can be reliably transmitted to the individual end faces 32, 33 so that they lie in perfect abutment with one another.

For the sake of good order, it should finally be pointed out that in order to provide a clearer understanding of the structure of the retaining device and the extrusion die, they and their constituent parts have been illustrated out of scale to a certain extent and/or on an enlarged and/or reduced scale.

The tasks underlying the independent inventive solutions can be found in the description.

Above all, subject matter relating to the individual embodiments illustrated in FIGS. 1; 2 to 4; 5; 6; 7; 8; 9; 10 to 13; 14; 15 can be construed as independent solutions proposed by the invention. The tasks and solutions can be found in the detailed descriptions relating to these drawings.

List of Reference Numbers

| | |
|---|---|
| 1 | Extrusion plant |
| 2 | Extruder |
| 3 | Shaping system |
| 4 | Crawler track |
| 5 | Article |
| 6 | Extrusion direction |
| 7 | Extrusion tool |
| 8 | Calibration system |
| 9 | Calibration tool |
| 10 | Calibration tool |
| 11 | Calibration tool |
| 12 | Calibration tool |
| 13 | Vacuum pressure tank |
| 14 | Vacuum pressure tank |
| 15 | Calibration plate |
| 16 | Container |
| 17 | Screw conveyor |
| 18 | Tempering system |
| 19 | Machine bed |
| 20 | Standing surface |
| 21 | Calibrating table |
| 22 | Roller |
| 23 | Track |
| 24 | Orifice |
| 25 | Shaping surface |
| 26 | Retaining device |
| 27 | Die plate |
| 28 | Extrusion die |
| 29 | Inlet region |
| 30 | Outlet region |
| 31 | Die lip |
| 32 | End face |
| 33 | End face |
| 34 | Side end |
| 35 | Side end |
| 36 | Flow passage |
| 37 | Tension element |
| 38 | Tempering element |
| 39 | End region |
| 40 | Holding element |
| 41 | Flat face |
| 42 | End region |
| 43 | Holding element |
| 44 | Tensioning mechanism |
| 45 | Rounded piece |
| 46 | Radius |
| 47 | Piston |
| 48 | Cylinder |
| 49 | Cylindrical chamber |
| 50 | Connecting device |
| 51 | Outlet |
| 52 | Threaded ring |
| 53 | Adjusting ring |
| 54 | Flange |
| 55 | Orifice |
| 56 | Flat face |
| 57 | Pressure system |
| 58 | Supporting element |
| 59 | Supporting element |
| 60 | Pressure element |
| 61 | Pressure generator |
| 62 | Cylindrical housing |
| 63 | Ram |
| 64 | Cylindrical chamber |
| 65 | Retaining element |
| 66 | Side face |
| 67 | Centring arrangement |
| 68 | Centring arrangement |
| 69 | Pre-tensioning mechanism |
| 70 | Tempering element |
| 71 | Supporting element |
| 72 | Support part |
| 73 | Orifice |
| 74 | Connecting part |
| 75 | Zone |
| 76 | Zone |
| 77 | Zone |
| 78 | Coupling mechanism |
| 79 | Coupling element |
| 80 | Coupling element |
| 81 | Locking element |
| 82 | Die-changing mechanism |
| 83 | Pivot plane |
| 84 | Arc |
| 85 | Arc |
| 86 | Guide post |
| 87 | Pivoting mechanism |
| 88 | Pivot pin |
| 89 | Pivot arm |
| 90 | Bearing arrangement |
| 91 | Bearing arm |
| 92 | Receiving orifice |
| 93 | Distance |
| 94 | Space |
| 95 | Connecting element |
| 96 | Clamping mechanism |
| 97 | Cylinder |
| 98 | Piston |
| 99 | Transition part |
| 100 | Clamping mechanism |

What is claimed is:

1. Retaining device, in particular on an extruder, for several die plates which can be arranged immediately one after the other in the extrusion direction to form an extrusion die with an inlet region and an outlet region, characterised in that at least two tension elements are provided spaced at a distance apart from one another perpendicular to the extrusion direction, which can co-operate with the die plates respectively in the region of opposing first side ends which they span, and the tension elements extend at least between the inlet region and the outlet region, at least one holding element in an end region of the tension element which may be directed towards the outlet region projects into the cross-sectional surface bounded by the side ends of the die plates disposed one after the other and engages round these side ends, and a clamping mechanism acting in the extrusion direction is provided for the die plates of the extrusion die between the two spaced apart end regions of the tension elements and/or between the tension elements and the die plates of the extrusion die co-operating therewith.

2. Retaining device as claimed in claim 1, characterised in that, at the two end regions spaced apart from one another in the extrusion direction, the tension element has a respective a holding element projecting above a flat face of the tension element towards the other oppositely lying tension element.

3. Retaining device as claimed in claim 2, characterised in that, on at least one of the end regions spaced apart from one another in the extrusion direction, the tension element has a supporting element extending above another flat face of the tension element on the sides remote from one another.

4. Retaining device as claimed in claim 2, characterised in that, at both of the end regions spaced apart from one another in the extrusion direction, the tension element respectively has a supporting element extending above the other flat face of the tension element on sides remote from one another.

5. Retaining device as claimed in claim 1, characterised in that the retaining element and the supporting element has a hook-shaped cross section in the direction of longitudinal extension and in a plane perpendicular to the flat faces of the tension element.

6. Retaining device as claimed in claim 1, characterised in that the two holding elements and support elements provided on at least one end region of the tension element have a hammer-shaped cross section extending respectively above the flat faces in the direction of longitudinal extension and perpendicular to the flat faces of the tension elements.

7. Retaining device as claimed in claim 1, characterised in that a transition region with a rounded piece is arranged between the tension element and the retaining element and supporting element.

8. Retaining device as claimed in claim 1, characterised in that the tension element is provided as a plate or bar-shaped component.

9. Retaining device as claimed in claim 1, characterised in that the tension element has a longitudinal extension in the extrusion direction that is longer than a length of the extrusion die co-operating therewith.

10. Retaining device as claimed in claim 1, characterised in that the tension element and the holding element and optionally the supporting element have a width transversely to the longitudinal extension of the tension element which more or less corresponds to a length of an end face of the die plate co-operating with the tension element in the same direction.

11. Retaining device as claimed in claim 1, characterised in that the tension elements are aligned parallel with one another and parallel with the extrusion direction in the operating position.

12. Retaining device as claimed in claim 1, characterised in that the clamping mechanism is provided in the form of a cylinder-piston arrangement.

13. Retaining device as claimed in claim 12, characterised in that the piston of the clamping mechanism can be supported on the end face of the first die plate directed towards the inlet region.

14. Retaining device as claimed in claim 12, characterised in that a connecting device is provided on the piston to retain it on the extruder.

15. Retaining device as claimed in claim 12, characterised in that the cylinder of the clamping mechanism is actively connected, in particular supported by, the two holding elements of the tension elements co-operating with the inlet region.

16. Retaining device as claimed in claim 12, characterised in that the cylinder has a radius on the portions assigned to the holding elements and co-operating therewith which complements the rounded piece.

17. Retaining device as claimed in claim 1, characterised in that a pressure system is assigned to the tension elements on the respective ends remote from one another, which preferably extends between the two end regions and actively co-operates therewith.

18. Retaining device as claimed in claim 17, characterised in that the pressure system runs at an angle to the tension element.

19. Retaining device as claimed in claim 18, characterised in that the pressure system is aligned in a converging arrangement in the extrusion direction or from the inlet region to the outlet region.

20. Retaining device as claimed in claim 17, characterised in that the pressure system comprises at least one pressure element and at least one pressure generator co-operating therewith.

21. Retaining device as claimed in claim 20, characterised in that the pressure element is a plate- or bar-shaped component.

22. Retaining device as claimed in claim 20, characterised in that the pressure element is supported on the supporting element on the side directed towards the outlet region and has a radius complementing the rounded piece.

23. Retaining device as claimed in claim 20, characterised in that the pressure generator has a cylindrical housing actively co-operating with the supporting element directed towards the inlet region and at least one ram disposed therein.

24. Retaining device as claimed in claim 23, characterised in that two co-operating rams are provided in the cylindrical housing.

25. Retaining device as claimed in claim 17, characterised in that the sum of active piston surfaces of the rams assigned to the pressure systems is the same as or greater than an active cylinder surface of the clamping mechanism.

26. Retaining device as claimed in claim 20, characterised in that a cylindrical chamber or clamping mechanism is connected by a line to the cylindrical chambers of the individual pressure generators.

27. Retaining device as claimed in claim 23, characterised in that the cylindrical housing has a respective radius complementing the rounded piece on the portions assigned to the supporting elements and co-operating therewith.

28. Retaining device as claimed in claim 23, characterised in that the two cylindrical housings are fixedly connected to one another by a specifically bar-shaped retaining element in the region of the end remote from the clamping mechanism.

29. Retaining device as claimed in claim 28, characterised in that the cylinder of the clamping mechanism has side faces which are directed towards the two holding elements and abut therewith.

30. Retaining device as claimed in claim 1, characterised in that a tempering element is arranged on at least one, preferably both of the flat faces of the mutually facing tension elements, at least in certain regions.

31. Retaining device as claimed in claim 30, characterised in that the tempering element is fixedly mounted on the tension element.

32. Shaping system with at least one extrusion die made up of individual die plates arranged one after the other and at least one flow passage arranged therein and a retaining device holding the die plates together in the extrusion direction, characterised in that the retaining device is designed as claimed in claim 1 and the individual die plates are held in abutment with one another by the retaining device in the operating position and whilst the mass flow is fed through the flow passage under pressure, by mutually facing end faces in the region of the flow passage, particularly in the first section thereof facing the inlet region, at a predeterminable minimum pressure which is approximately 20% higher than the mass pressure of the mass flow in this portion.

33. Shaping system as claimed in claim 32, characterised in that the predeterminable minimum pressure between abutting end faces is applied around the entire circumference of the flow passage.

34. Shaping system as claimed in claim 32, characterised in that a centring arrangement is provided between the piston of the clamping mechanism and the end face of the die plate directed towards the inlet region.

35. Shaping system as claimed in claim 32, characterised in that the piston of the clamping mechanism has an orifice, which is in flow communication with the flow passage in the die plates.

36. Shaping system as claimed in claim 32, characterised in that the die plate assigned to the outlet region and co-operating with the tension elements and the holding elements has a respective radius complementing the rounded piece in the portions co-operating therewith.

37. Shaping system as claimed in claim 32, characterised in that at least one clamping mechanism is assigned to the individual die plates forming the extrusion dies in the region of the other side ends and holds the die plates together in the preparation and removal position.

38. Shaping system as claimed in claim 37, characterised in that the clamping mechanism is assigned respectively to the two other side ends.

39. Shaping system as claimed in claim 37, characterised in that at least one tempering element is assigned to the clamping mechanism or mechanisms and preferably abuts with the side ends.

40. Shaping system as claimed in claim 32, characterised in that at least one supporting element is assigned to the die plates of the extrusion die, which can be connected to a pivot mechanism of a die-changing mechanism.

41. Shaping system as claimed in claim 40, characterised in that the supporting element is fixedly connected to one of the clamping mechanisms.

42. Shaping system as claimed in claim 32, characterised in that another extrusion die is retained on an extrusion die when in the operating position and fixedly, mounted on the retaining device and is retained parallel with the first extrusion die in the region of one of the side ends of the die plates.

43. Shaping system as claimed in claim 40, characterised in that when the first extrusion die is released from the retaining device, it can be moved into the removal position by means of the die-changing mechanism.

44. Shaping system as claimed in claim 43, characterised in that the displacement from the release position into the removal position is effected by a pivoting motion along an arc.

45. Shaping system as claimed in claim 44, characterised in that the pivoting motion is effected in a horizontal pivot plane.

46. Shaping system as claimed in claim 42, characterised in that the two extrusion dies co-operating with one another are held in position one against the other by means of a coupling mechanism provided on the clamping mechanisms and the two extrusion dies coupled with one another are pivoted together with one another.

47. Shaping system as claimed in claim 40, characterised in that the supporting elements are arranged on opposing side ends of the two extrusion dies and the supporting elements are rotatable about a vertically aligned pivot pin on a support arm of the die-changing mechanism.

48. Shaping system as claimed in claim 47, characterised in that the two support arms are respectively pivotable or rotatable about an axis perpendicular to the pivot plane of a bearing arrangement, being linked to a pivot arm co-operating therewith.

49. Shaping system as claimed in claim 48, characterised in that the two pivot arms are disposed perpendicular to the pivot plane and mounted transversely to guide posts spaced at a distance apart from one another in the extrusion direction.

50. Shaping system as claimed in claim 48, characterised in that the two support arms are coupled with one another by means of a connecting element, and in particular are rigidly connected to one another.

51. Shaping system as claimed in claim 49, characterised in that the pivot arms of the pivot mechanism are mounted so as to be slidable along the guide posts if necessary.

52. Shaping system as claimed in claim 49, characterised in that the guide posts are fixedly retained on the two retaining elements of the retaining device.

53. Shaping system as claimed in claim 32, characterised in that the individual die plates are approximately of the same external dimension in a plane perpendicular to the extrusion direction.

54. Shaping system as claimed in claim 32, characterised in that centring elements are provided between the die plates arranged immediately one after the other.

55. Method of retaining at least one extrusion die made up of several die plates arranged immediately one after the other, whereby the clamping forces to be applied in the operating position and during the extrusion process are transmitted by means of at least two oppositely lying tension elements externally spanning the extrusion die at its side ends and holding elements projecting into the cross-sectional surface formed by the side ends in the inlet region and outlet region of the extrusion die and engaging round these side ends, into the individual die plates and the die plates are brought into abutment with one another continuously by mutually facing end faces without any clearance, continuously in a region enclosing a flow passage.

56. Method as claimed in claim 55, characterised in that heat is applied to another extrusion die made up of several die plates arranged one after the other in its preparation position, after which the extruder is stopped and the first extrusion die is released from the retaining device and the released first extrusion die together with the mass flow of softened plastics material disposed therein is lifted away from the outlet of the extruder more or less in the extrusion direction, the mass flow between the outlet from the extruder and the inlet region to the extrusion die being stretched and expanded and the stretched mass flow being simultaneously separated with this displacement, after which the displacement is continued until the removal position is reached and the other extrusion die is moved from its preparation position into the release position and the other extrusion die is then fixedly retained on the extruder with the retaining device.

57. Method as claimed in claim 56, characterised in that, immediately prior to positioning the other extrusion die on the extruder, the mass flow still emerging from the extruder is removed.

58. Method as claimed in claim 55, characterised in that, prior to effecting the displacement, the two extrusion dies are coupled with one another and the two extrusion dies are displaced jointly with one another.
